(19) United States
(12) Patent Application Publication
(10) Pub. No.: US 2022/0388236 A1
(43) Pub. Date: Dec. 8, 2022

(54) 3D SCREEN PRINTING FACILITY AND 3D SCREEN PRINTING METHOD FOR PRODUCING A SHAPED ARTICLE

(71) Applicant: S.A.S. 3DCERAM-SINTO, Bonnac La Côte (FR)

(72) Inventor: Susanne LÜHR, Clausthal-Zellerfeld (DE)

(21) Appl. No.: 17/638,292

(22) PCT Filed: Aug. 25, 2020
(86) PCT No.: PCT/EP2020/073745

§ 371 Date: Feb. 25, 2022

(30) Foreign Application Priority Data
Aug. 28, 2019 (DE) 10 2019 123 128.0

(51) Int. Cl. B29C 64/153; B29C 64/241; B29C 64/286; B29C 64/245; B29C 64/232; B29C 64/209; B29C 64/295; B33Y 10/00; B33Y 30/00

(52) U.S. Cl. CPC B29C 64/153; B29C 64/241; B29C 64/286; B29C 64/245; B29C 64/232; B29C 64/209; B29C 64/295; B33Y 10/00; B33Y 30/00

(57) ABSTRACT

A 3D screen-printing apparatus for producing a shaped article includes: a printing table; a printing screen with a printing mask having a layer geometry for producing the shaped article layer by layer; an application unit to apply a printing material to the printing screen and to work it into the printing masks to produce a shaped-article layer; and a first positioning unit configured to increase the distance between the printing table and the printing screen by way of a first relative movement after the production of each shaped-article layer. The printing screen has printing masks, and the 3D screen-printing apparatus has a second positioning unit configured to perform a second relative movement between the printing table and the printing screen so different printing masks of the one printing screen can be positioned one after the other at a shaped-article position where an individual shaped article is to be built.

### CROSS-RELATED TO PRIOR APPLICATIONS

This application is the U.S. national phase of International Application No. PCT/EP2020/073745 filed Aug. 25, 2020 which designated the U.S. and claims priority to DE 102019123128.0 filed Aug. 28, 2019, the entire contents of each of which are hereby incorporated by reference.

### BACKGROUND OF THE INVENTION

### Field of the Invention

3D screen-printing apparatus and 3D screen-printing method for producing a shaped article

The invention relates to a 3D screen-printing apparatus for producing at least one shaped article in a 3D screen-printing method, in which the shaped article is to be built up layer by layer. The invention also relates to a method for producing such a shaped article in a 3D screen-printing method.

### Description of the Related Art

In the generative or additive manufacturing methods, shaped articles (three-dimensional objects) are produced by building them up layer by layer. In the widely used representative of this manufacturing technology, 3D printing, either a liquid or solid material is output from a printing head at a predetermined position, or a material is solidified within a structural space by means of a heat source, thus enabling the production of three-dimensional geometries of almost limitless complexity.

A further and hitherto not so widely used additive manufacturing method is 3D screen printing, or a 3D screen-printing method. Herein, a printing material is applied to a printing screen, comprising a printing mask, and worked into the printing mask by means of a doctor blade so that the cavity provided by the printing mask in the printing screen is filled by the printing material. The printing material is usually a powder-based suspension, or a pasty material. Subsequently, the distance between the printing screen and the printing table, on which the shaped article is being produced, is increased by the thickness amount of the printing screen so that another layer of the shaped article can be produced by means of the printing mask on the already existing portion of the shaped article. Usually, the already existing portion of the shaped article is temperature-controlled by a heating unit to ensure a certain minimum strength of the shaped article by drying or setting for further processing.

This can enable one layer after the other of the shaped article to be produced in a 3D screen-printing method, wherein, however, only so-called 2.5 D structures can be built, since the printing screen must be exchanged for each change in cross-section of the component in the plane of the printing screen and the build platform.

Therefore, the hitherto known 3D screen-printing method is not fully flexible, such as is the case, for example, in other additive or generative manufacturing methods, since it does not provide the freedom in design with respect to shape and geometry as provided by other additive or generative manufacturing methods. Rather, the 3D screen-printing method is usually used when shaped articles are to be produced having an invariable cross-section over their length (so-called 2.5 D geometries).

For shaped articles that are to be composed of several different cross-sections, however, there is a problem in that the printing screen with the printing mask comprised therein must be exchanged for each change in cross-section, resulting in long setup times of the corresponding apparatus. This is because the printing screen no longer needed must be removed from the apparatus and the new printing screen having the desired cross-sections has to be installed.

Components or shaped articles having constantly varying cross-sections in all three spatial directions are entirely unsuited for a 3D screen-printing method. These component geometries are, in particular, screw-like or propeller-like structures.

Since the 3D screen-printing method is particularly suitable as an additive manufacturing method for the production of components in large numbers, it is desirable to be able to also produce component geometries with varying, constantly varying or alternating cross-sections with the aid of such an additive manufacturing method.

### SUMMARY OF THE INVENTION

It is thus an object of the present invention to provide an improved 3D screen-printing apparatus, and an improved 3D screen-printing method, with which varying, constantly varying or alternating cross-sections of any desired complexity can be produced.

According to the present invention, the method is achieved by the 3D screen-printing apparatus disclosed and claimed, and the 3D screen-printing method also disclosed and claimed.

In a first embodiment, a 3D screen-printing apparatus is provided which is suitable for the manufacture of at least one shaped article, preferably a plurality of shaped articles simultaneously, in an additive manufacturing method, i.e., in a 3D screen-printing method, in which the at least one shaped article is built up layer by layer by means of the 3D screen-printing apparatus.

Generically, the 3D screen-printing apparatus has a printing table, on which the at least one shaped article is producible, or is to be produced layer by layer. Furthermore, the 3D screen-printing apparatus comprises a printing screen including at least one printing mask, wherein each printing mask includes the layer geometry for producing each shaped article layer by layer.

Moreover, the 3D screen-printing apparatus generically includes an application unit configured to apply a printing material onto the printing screen and to work it into the printing masks for producing a shaped-article layer. The application unit can include one or more doctor blades (flood blades) used to spread the printing material on the printing screen and to press or work it into the cavities of the printing masks.

Finally, the generic 3D screen-printing apparatus has a first positioning unit adapted to increase the distance between the printing table and the printing screen after the production of each shaped-article layer by a first relative movement. To achieve this, the first positioning unit can cooperate with the printing screen so that lifting of the printing screen causes a relative movement between the printing screen and the printing table to increase the distance between the printing screen and the printing table. However, it is also conceivable that the first positioning unit cooperates with the printing table in such a manner that it is lowered after the production of each shaped-article layer to thus generate the first relative movement between the printing screen and the printing table to increase the distance between the printing screen and the printing table. Finally, a combination of the two is also conceivable.

According to the invention, it is provided that the printing screen includes a plurality of printing masks and the 3D screen-printing apparatus has a second positioning unit adapted to perform a second relative movement between the printing table and the printing screen in such a manner that different printing masks on the printing screen are positionable one after the other at a shaped-article position, where an individual shaped article is to be built.

It is thus suggested that the printing screen includes a plurality of printing masks, wherein different printing masks, on which the screen-printing process is then based, are positioned one after the other at a certain shaped-article position where an individual shaped article is to be produced. The positioning of a new printing mask is performed by means of a second relative movement between the printing table and the printing screen in such a manner, in particular, that the printing screen is not removed from the apparatus. Rather, the printing screen remains in the apparatus, and a new printing mask is only positioned in relation to the predetermined shaped-article position. However, this does not preclude the possibility of exchanging the printing screen during the process.

In other words, the 3D screen-printing apparatus is adapted, in a first process step, to produce a first shaped-article layer of each shaped article using a first printing mask of the printing screen, then, after producing this first shaped-article layer, to perform a relative movement between the printing table and the printing screen by the second positioning unit so that a second printing mask of the printing screen is positioned at the shaped-article position of each shaped article, and subsequently, in a second process step, to produce a second shaped-article layer on top of the first shaped-article layer using the second printing mask of the printing screen.

By these means, shaped articles, or components, can be produced in a 3D screen-printing method, which have varying, constantly varying, or alternating cross-sections of almost any complexity. In particular, screw-like or propeller-like structures can be produced in a 3D screen-printing method, as will be shown in more detail below.

Further, the invention offers the possibility to produce components with varying cross-sections in a 3D screen-printing method without the need for long setup times of the 3D screen-printing apparatus. Rather, this allows components with varying cross-sections to be produced in a rapid and efficient manner.

A printing mask, as used in the present invention, is that region in a printing screen, by which a shaped-article layer having a corresponding layer geometry can be produced. The region of the printing mask has one or more cavities into which the printing material is worked to produce the shaped-article layer having the layer geometry predefined by the printing mask. According to the invention, the printing screen has several printing masks having the same, i.e. identical, or different layer geometries.

The first relative movement and the second relative movement, as used in the present invention, are movements different from each other which can, however, also be simultaneously performed. The first positioning unit and the second positioning unit can be discrete units, or they can be a combined positioning unit. In particular, the second relative movement does not change the distance between the printing screen and the printing table.

The second positioning unit can cooperate with either the printing table and/or the printing screen to perform the second relative movement. A movement of the printing table, without moving the printing screen, can thus implement the second relative movement. It is also conceivable, however, that a movement of the printing screen, without moving the printing table, implements the second relative movement. Finally, a combination of the two is also conceivable.

According to an embodiment, it is provided that the second positioning unit is formed so that the second relative movement between the printing table and the one printing screen is performed within the plane defined by the printing table or the printing screen. Herein, the printing table and/or the printing screen are moved in parallel with respect to the printing table, or to the individual shaped-article layers, so that after performing the second relative movement, a further shaped-article layer can be produced by one or more printing masks. In particular, the second relative movement does not change the distance between the printing table and the printing screen.

According to an embodiment, it is provided that the second positioning unit is configured to perform the second relative movement between the printing table and the one printing screen as a rotatory and/or translatory movement. Consequently, the printing table and/or the printing screen are moved by the second positioning unit in a rotatory and/or translatory manner to position, one after the other, different printing masks of the one printing screen at a respective shaped-article position.

According to an embodiment, it is provided that the 3D screen-printing apparatus has a heating unit adapted to control the temperature of the shaped article and/or an individual shaped-article layer. It is thus conceivable, after the production of each shaped-article layer, to control the temperature of the shaped-article layer last produced to cure/to dry it at least to a point where a further shaped-article layer can be produced on top of the already produced shaped-article layers. It is also conceivable, however, after producing the complete shaped article, i.e., after producing the last shaped-article layer, for the component to be temperature-controlled in its entirety and to be fully cured in a sintering process.

According to an embodiment, it is provided that the second positioning unit is configured to perform a rotatory relative movement between the printing table and the one printing screen about a rotary axis, wherein a plurality of printing masks are arranged in the printing screen on at least one concentric circle about the rotary axis. Herein, either the printing table or the printing screen or both can be rotated about the rotary axis, to position, one after the other, each of the printing masks arranged on the concentric circle about the rotary axis at a predetermined shaped-article position.

In this way it is possible to position each new printing mask one after the other by generating a relative movement about a certain angle at different shaped-article positions without the printing screen having to be removed from the apparatus. Rather, several shaped articles having varying cross-sections, in particular screw-like or propeller-like structures, can be produced simultaneously and in parallel.

According to an embodiment of this, it is provided that a plurality of concentric circles are provided in the printing screen about a rotary axis, on each of which a plurality of printing masks are arranged.

According to an embodiment of this, it is provided that all printing masks arranged in the printing screen on a common concentric circle about the rotary axis are identical with respect to the layer geometry to be produced and/or their geometric alignment.

The sequential positioning of the printing masks at a predetermined shaped-article position, can thus achieve that the printing masks constantly vary with respect to the shaped-article position regarding their geometric alignment, thus enabling screw-like or propeller-like structures to be rapidly and efficiently produced.

According to an embodiment it is provided that all printing masks in the printing screen are equidistantly arranged on the common concentric circle about the rotary axis, wherein the angle between two printing masks corresponds to an integer multiple of a full circle.

A method for producing at least one shaped article in a 3D screen-printing method is provided, in which the shaped article is to be built up layer by layer, said method comprising the steps of:
applying a printing material on a printing screen having a plurality of printing masks each having a layer geometry for producing the at least one shaped article layer by layer on a printing table, and working the printing material into at least one printing mask of the printing screen for producing a shaped-article layer;
wherein, after the production of each shaped-article layer, by means of a first relative movement, the distance between the printing table and the printing screen is increased; and
performing at least one second relative movement between the printing table and the printing screen by means of a second positioning unit in such a manner that different printing masks of the one printing screen are positioned one after the other at a shaped-article position, where the at least one shaped article is to be built.

Advantageous embodiments of the method can be derived from the corresponding dependent claims.

Materials to be used for screen printing can be ceramic, metal, glass, plastic, as well as mixtures of all these material groups or composite mixtures. Moreover, from the group of ceramics, silicon carbide, corundum, aluminum oxide, zirconium oxide, Cordierite, phosphate ceramics and clay-containing ceramics are conceivable. From the group of glass materials, in particular, silicon is conceivable. From the group of metals, stainless steel, iron or ferrous metals, copper, tungsten, molybdenum, and aluminum are conceivable. Plastics, such as acrylates or silicones, are also possible.

### BRIEF DESCRIPTION OF THE DRAWINGS

The invention will be explained in more detail with reference to the accompanying drawings, in which:

FIG. 1 shows a schematic diagram of the 3D screen-printing apparatus;

FIG. 2 schematically shows a diagram of a printing screen of the 3D screen-printing apparatus according to the invention; and

FIG. 3 shows an exemplary diagram of the variation of the printing mask due to the second relative movement.

### DESCRIPTION OF THE PREFERRED EMBODIMENTS

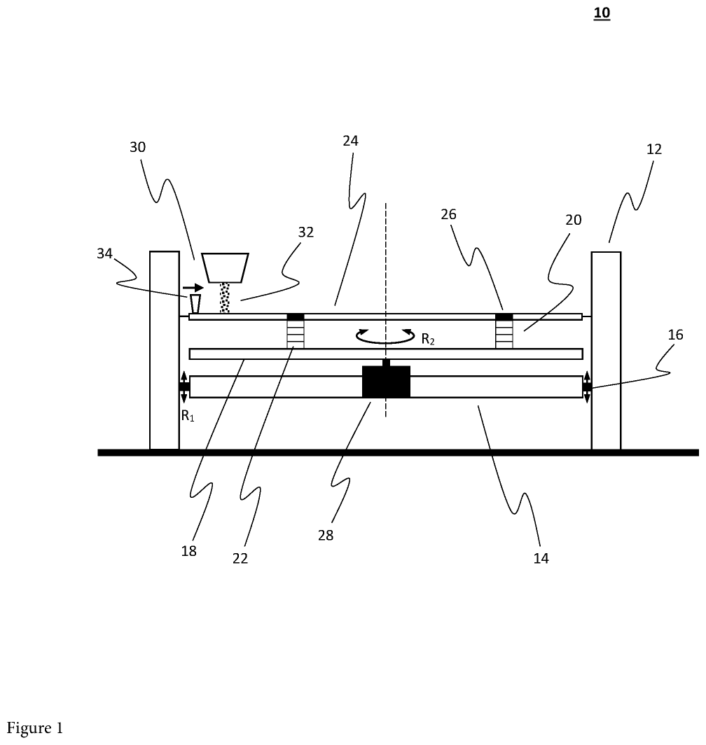

FIG. 1 schematically shows the 3D screen-printing apparatus 10 according to the invention, including its generic and, in particular, novel elements. The apparatus 10 has a frame 12 on which a supporting frame 14 is arranged to be vertically movable by means of a first positioning unit 16.

Furthermore, on the supporting frame 14, a printing table 18 is arranged, on which one or more shaped articles 20 are to be produced layer by layer from individual shaped-article layers 22. Above the printing table 18, on the frame 12, furthermore, a printing screen 24 is fixedly arranged allowing the individual shaped-article layers 22 to be produced by means of the printing masks 26 provided in the printing screen 24.

If the supporting frame 14 is now vertically moved by means of the first positioning unit 16, the printing table 18 is also vertically moved so that, due to this first relative movement R₁, the distance between the printing table 18 and the printing screen 24 can be changed, in particular, increased.

Furthermore, the apparatus 10 comprises an application unit 30 allowing a printing material 32 to be applied on the top surface of the printing screen 24. A doctor blade 34, able to be traversed with respect to the printing screen 24, allows the printing material 32 to be spread on the printing screen 24 and to be worked into the printing masks 26 of the printing screen 24.

Furthermore, the screen-printing apparatus 10 comprises a second positioning unit 28 arranged between the supporting frame 14 and the printing table 18 and cooperating with the printing table 18 in such a manner that the latter can be rotatably moved about the rotary axis D. The printing table 18 is thus attached above the second positioning unit 28 within the screen-printing apparatus 10 in such a way that the printing table 18 is able to be relatively moved with respect to the supporting frame 14 and the printing screen 24. The relative movement thus generated is indicated as R₂.

Rotating the printing table 18 thus enables the positioning of different printing masks 26 at a shaped-article position where a particular shaped article 20 is to be produced to thus implement different cross-sections without having to equip the screen-printing apparatus with a new printing screen.

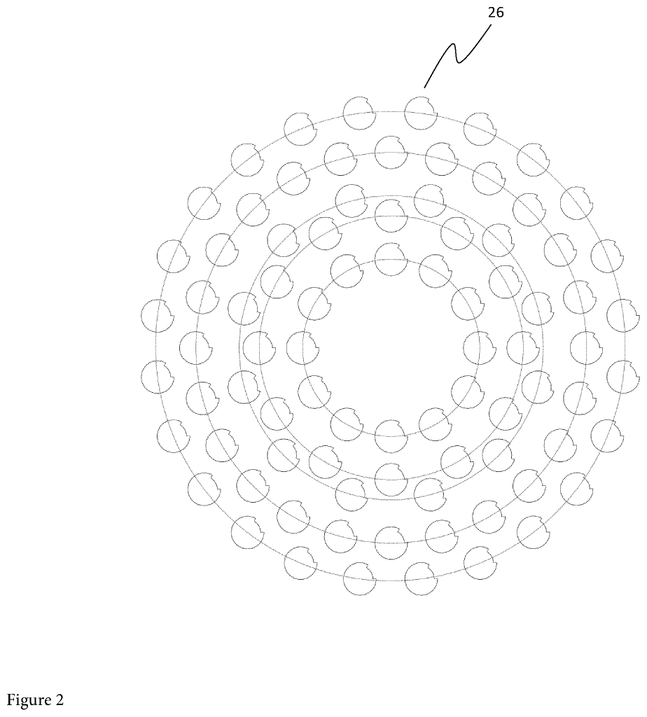

FIG. 2 shows an advantageous embodiment in which the printing masks 26 are equidistantly grouped in concentric circles about the rotary axis D on the printing screen 24. At each position where there is a printing mask 26 in the printing screen 24 an individual shaped article can be produced as long as the angle between two printing masks 26 equidistantly arranged on a common concentric circle about the rotary axis D corresponds to an integer multiple of a full circle, which means that the printing masks 26 are not rotated with respect to each other. When, due to the relative movement, the alignment between the printing table and the printing screen is changed by exactly the angle which causes the printing masks 26, preceding against the direction of rotation, on a concentric circle, to fall on the next subsequent printing mask 26 or the one after that or even after that et cetera, of the component geometry, each subsequent, forth-following, et cetera, printing mask is positioned, at each position formed by a corresponding printing mask 26 in the printing screen 24, at the corresponding shaped-article position.

The embodiment of FIG. 2 also shows that each printing mask 26 in the printing screen 24 has an identical layer geometry and an identical geometric alignment. Due to the relative movement between the printing table 18 and the printing screen 24, the geometric alignment of the printing masks 26 in relation to a corresponding shaped-article position varies by exactly the angle needed for the translatory movement of the one mask to the other on the concentric circle which allows screw-like or propeller-like shaped articles to be produced, in particular.

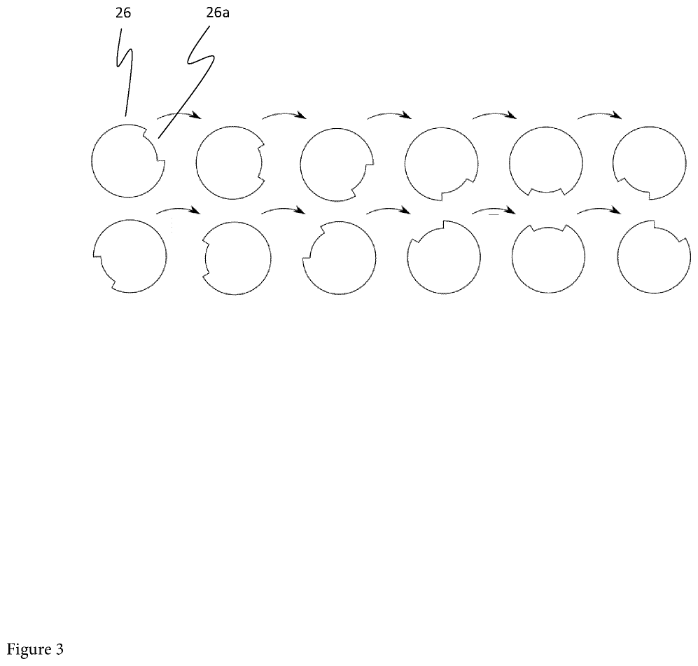

Such a change of the printing mask in relation to a corresponding shaped-article position is shown in FIG. 3. At a corresponding shaped-article position, the printing mask 26 changes regarding its geometric alignment at each relative movement about the corresponding angle so that the one recess 26a provided in the printing mask 26 has a different alignment for each relative movement.

### LIST OF REFERENCE NUMERALS

10 3D screen-printing apparatus

12 frame

14 supporting frame

16 first positioning unit

18 printing table

20 shaped article

22 shaped-article layer

24 printing screen

26 printing mask

28 second positioning unit

30 application unit

32 printing material

34 doctor blade

D rotary axis

R₁ first relative movement

R₂ second relative movement

1. A 3D screen-printing apparatus for producing at least one shaped article in a 3D screen-printing method, in which the shaped article is to be built up layer by layer, the 3D screen-printing apparatus comprising:
a printing table on which the at least one shaped article can be produced layer by layer;
a printing screen having at least one printing mask which has a layer geometry for producing the shaped article layer by layer;
an application unit configured to apply a printing material onto the printing screen and to work said material into the printing masks to produce a shaped-article layer; and
a first positioning unit configured to increase the distance between the printing table and the printing screen by way of a first relative movement after the production of each shaped-article layer;
wherein the printing screen comprises a plurality of printing masks, and the 3D screen-printing apparatus has a second positioning unit configured to perform a second relative movement between the printing table and the printing screen in such a way that different printing masks of the printing screen are positionable one after the other at a shaped-article position, where an individual shaped article is to be built.

2. The 3D screen-printing apparatus according to claim 1, wherein the second positioning unit is designed in such a way that the second relative movement between the printing table and the printing screen is performed within the plane defined by one of the printing table and the printing screen.

3. The 3D screen-printing apparatus according to claim 1, wherein the second positioning unit is configured to perform the second relative movement between the printing table and the printing screen as at least one of a rotatory and a translatory movement.

4. The 3D screen-printing apparatus according to claim 1, wherein the 3D screen-printing apparatus has a heating unit configured to control the temperature of at least one of the shaped article andan individual shaped-article layer.

5. The 3D screen-printing apparatus according to claim 1, wherein the second positioning unit is configured to perform a rotatory relative movement between the printing table and the printing screen about a rotary axis, wherein a plurality of printing masks are arranged in the printing screen on at least one concentric circle about the rotary axis.

6. The 3D screen-printing apparatus according to claim 5, wherein a plurality of concentric circles about the rotary axis are provided in the printing screen, a plurality of printing masks being arranged on each one of the plurality of concentric circles.

7. The 3D screen-printing apparatus according to claim 5, wherein all printing masks arranged in the printing screen on a common concentric circle about the rotary axis, are identical regarding at least one of the layer geometry to be produced and the geometric alignment.

8. The 3D screen-printing apparatus according to claim 5, wherein all printing masks in the printing screen are equidistantly arranged on the common concentric circle about the rotary axis, wherein the angle between two printing masks corresponds to an integer multiple of a full circle.

9. A method for producing at least one shaped article in a 3D screen-printing method, in which the shaped article is to be built up layer by layer, the method comprising the steps of:
applying a printing material on a printing screen having a plurality of printing masks, each printing mask having a layer geometry for producing at least one shaped article layer by layer on a printing table, and working the printing material into at least one printing mask of the printing screen for producing a shaped-article layer;
wherein, after the production of each shaped-article layer, by means of a first relative movement, the distance between the printing table and the printing screen is increased; and
performing at least one second relative movement between the printing table and the printing screen by means of a second positioning unit in such a manner that different printing masks of the one printing screen are positioned one after the other at a shaped-article position, where the at least one shaped article is to be built.

10. The method according to claim 9, further comprising a first step of:
providing a 3D-printing apparatus for producing at least one shaped article in a 3D screen-printing method, in which the shaped article is to be built up layer by layer, the 3D screen-printing apparatus comprising:
a printing table on which the at least one shaped article can be produced layer by layer;
a printing screen having at least one printing mask which has a layer geometry for producing the shaped article layer by layer;
an application unit configured to apply a printing material onto the printing screen and to work said material into the printing masks to produce a shaped-article layer; and
a first positioning unit configured to increase the distance between the printing table and the printing screen by way of a first relative movement after the production of each shaped-article layer;
wherein the printing screen comprises a plurality of printing masks, and the 3D screen-printing apparatus has a second positioning unit configured to perform a second relative movement between the printing table and the printing screen in such a way that different printing masks of the printing screen are positionable one after the other at a shaped-article position, where an individual shaped article is to be built; then
performing the method for producing at least one shaped article using the 3D-printing apparatus.

11. The method according to claim 9, wherein the second relative movement between the printing table and the printing screen is performed by means of the second positioning unit within the plane defined by at least one of the printing table and the printing screen.

12. The method according to claim 9, wherein the second relative movement between the printing table and the printing screen is performed as at least one of a rotatory and a translatory movement.

13. The method according to claim 9, wherein the temperature of the shaped article is controlled by means of a heating unit.

14. The method according to claim 9, wherein a rotatory relative movement between the printing table and the printing screen is performed about a rotary axis by means of the second positioning unit, wherein the printing material is applied to a printing screen, in which a plurality of printing masks are arranged on at least one concentric circle about the rotary axis, wherein the printing material is worked into the printing masks for producing the shaped-article layer.

15. (canceled)

16. The method according to claim 9, wherein the temperature of each individual shaped-article layer is controlled by means of a heating unit.

17. The 3D screen-printing apparatus according to claim 2, wherein the second positioning unit is configured to perform the second relative movement between the printing table and the printing screen as at least one of a rotatory and a translatory movement.

18. The 3D screen-printing apparatus according to claim 2, wherein the 3D screen-printing apparatus has a heating unit configured to control the temperature of at least one of the shaped article andan individual shaped-article layer.

19. The 3D screen-printing apparatus according to claim 3, wherein the 3D screen-printing apparatus has a heating unit configured to control the temperature of at least one of the shaped article andan individual shaped-article layer.

20. The 3D screen-printing apparatus according to claim 2, wherein the second positioning unit is configured to perform a rotatory relative movement between the printing table and the printing screen about a rotary axis, wherein a plurality of printing masks are arranged in the printing screen on at least one concentric circle about the rotary axis.

21. The 3D screen-printing apparatus according to claim 3, wherein the second positioning unit is configured to perform a rotatory relative movement between the printing table and the printing screen about a rotary axis, wherein a plurality of printing masks are arranged in the printing screen on at least one concentric circle about the rotary axis.
